(19) United States
(12) Patent Application Publication
(10) Pub. No.: US 2021/0018212 A1
(43) Pub. Date: Jan. 21, 2021

(54) Cloud-based AI powered indoor environment system and method for smart climate technology control for buildings

(71) Applicants: Dmytro Prisikar, Oslo (NO); Mykhailo Prisikar, Espoo (FI)

(72) Inventors: Dmytro Prisikar, Oslo (NO); Mykhailo Prisikar, Espoo (FI)

(21) Appl. No.: 16/933,243

(22) Filed: Jul. 20, 2020

Related U.S. Application Data
(60) Provisional application No. 62/875,996, filed on Jul. 19, 2019.

(51) Int. Cl. F24F 11/80; F24F 11/46; G06N 20/00

(52) U.S. Cl. CPC F24F 11/80; F24F 2110/10; G06N 20/00; F24F 11/46

(57) ABSTRACT

The present invention is a smart indoor environment technology that improves energy consumption in buildings. Using sensors, the system collects large amounts of data on indoor climate, air quality, and space usage for each room. The data are then processed by machine learning algorithms. The algorithms optimize the work of building systems such as heating, ventilation and air conditioning (HVAC), lighting, and other electronic building systems. This way, the present invention minimizes electric power consumption for a building, and improves air quality and temperature comfort in the premises. By making consumption of electricity smarter, buildings become more energy efficient. This, in its turn, also results in reduction of CO2 emissions by the buildings.

### TECHNICAL FIELD OF THE INVENTION

The subject matter disclosed herein relates generally to the field of building automation systems. More specifically, the present technology description relates to control systems for premise heating, ventilation, air conditioning, lighting, water heating, elevation systems, and other buildings' systems that could be controlled by means of software products.

### BACKGROUND OF THE INVENTION

According to US EPA, studies from the United States and Europe show that persons in industrialized nations spend more than 90 percent of their time indoors. And for small children, the elderly, persons with chronic diseases, and most urban residents of any age, the proportion is even higher.

To control the energy consumption of building processes, building management systems (BMS) are commonly used in non-residential buildings. However, current BMS solutions are wasteful compared to smarter solutions, as they are building-centric (sensors alone dictating comfort status) rather than human-centric. Being unable to properly track number of occupants and their movements, as well as missing the valuable input of dynamic feedback from occupants, the BMS will always be out of sync with the real-time conditions in the building and the needs of those inside.

By constantly analyzing data for indoor environment, and enhancing air quality and temperature comfort in buildings, the present invention improves mental and physical wellness of visitors.

The present invention is designed for: Offices, Hotels and restaurants, Shopping centers, Public administration buildings, Schools and universities, Hospitals and clinics, Passenger ships, trains, and other transportation, and offshore platform living quarters. The present invention is a solution for: Smart cities, Electric power grids, and Electricity producers and distributors.

The present invention complements existing control systems with intelligence and automation well beyond state-of-the-art. It empowers occupants to reduce energy waste in their workplace and enables dynamic occupant feedback to the control systems regarding personal and pooled levels of comfort and preference. Learning from these data, machine learning algorithms control and optimize building processes to reduce energy consumption and CO2 emissions, as well as adjust indoor comfort according to the comfort preferences of who is in the building.

### DEFINITIONS

Unless stated to the contrary, for the purposes of the present disclosure, the following terms shall have the following definitions:

Administrators, commonly known as admins or sysops (system operators), are software or system users who have been granted the technical ability to perform certain special actions.

Artificial intelligence (AI) is the simulation of human intelligence processes by machines, especially computer systems. These processes include learning (the acquisition of information and rules for using the information), reasoning (using rules to reach approximate or definite conclusions) and self-correction.

“Building Democracy” and “Democracy in buildings/rooms” is used in the present application to define and describe the voting process taught by the method of the present invention and enabled by the software applications and “apps” displayed to users. “Building Democracy” is the voting process that enables a method and process which provides a

“Democracy in buildings/rooms”. Through the software application or “apps” of the present invention, individuals in a building exercise power by voting for such things as air temperature by controlling an HVAC system, water temperature, lighting levels through direct lighting and indirect through window controls and other settings and controls of a building, then a computer algorithm takes the voting input and makes control decision over the building systems based on the individual voter input.

The Global Positioning System (GPS) is a space-based navigation system that provides location and time information in all weather conditions, anywhere on or near the earth where there is an unobstructed line of sight to four or more GPS satellites. The system provides critical capabilities to military, civil, and commercial users around the world. The United States government created the system, maintains it, and makes it freely accessible to anyone with a GPS receiver.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society “Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

BLUETOOTH is a wireless technology standard for exchanging data over short distances (using short-wavelength UHF radio waves in the ISM band from 2.4 to 2.485 GHz) from fixed and mobile devices and building personal area networks (PANs).

BLUETOOTH low energy (Bluetooth LE, BLE, marketed as BLUETOOTH SMART) is a wireless personal area network technology designed and marketed by the Bluetooth Special Interest Group aimed at novel applications in the healthcare, fitness, beacons, security, and home entertainment industries.

A client is a piece of computer hardware or software that accesses a service made available by a server. The server is often (but not always) on another computer system, in which case the client accesses the service by way of a network. The term applies to programs or devices that are part of a client-server model.

Cloud computing is the on-demand availability of computer system resources, especially data storage and computing power, without direct active management by the user. The term is generally used to describe data centers available to many users over the Internet. Large clouds, predominant today, often have functions distributed over multiple locations from central servers.

If the connection to the user is relatively close, it may be designated an edge server. Clouds may be limited to a single organization (enterprise clouds), be available to many organizations (public cloud), or a combination of both (hybrid cloud).

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

A gateway is a link between two computer programs or systems such as Internet Forums. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The internet of things, or IoT, is a system of interrelated computing devices, mechanical and digital machines, objects, animals or people that are provided with unique identifiers (UIDs) and the ability to transfer data over a network without requiring human-to-human or human-to-computer interaction.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

iOS (originally iPhone OS) is a mobile operating system created and developed by Apple Inc. and distributed exclusively for Apple hardware. It is the operating system that presently powers many of the company's mobile devices, including the iPhone, iPad, and iPod touch.

Machine learning (ML) is the scientific study of algorithms and statistical models that computer systems use in order to perform a specific task effectively without using explicit instructions, relying on patterns and inference instead. It is seen as a subset of artificial intelligence. Machine learning algorithms build a mathematical model based on sample data, known as “training data”, in order to make predictions or decisions without being explicitly programmed to perform the task.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from wherever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component. An operating system (OS) is software that manages computer hardware and software resources and provides common services for computer programs. The operating system is an essential component of the system software in a computer system. Application programs usually require an operating system to function.

Push Notification, Push, or server push describes a style of Internet-based communication where the request for a given transaction is initiated by the publisher or central server. It is contrasted with pull/get, where the request for the transmission of information is initiated by the receiver or client.

A server is a running instance of an application (software) capable of accepting requests from the client and giving responses accordingly. Servers can run on any computer including dedicated computers, which individually are also often referred to as “the server”.

A smart device is an electronic device, generally connected to other devices or networks via different wireless protocols such as Bluetooth, NFC, Wi-Fi, LiFi, 3G, etc., that can operate to some extent interactively and autonomously.

“SMS” (short message service) is a text messaging service component of most telephone, internet, and mobile-device systems. It uses standardized communication protocols to enable mobile devices to exchange short text messages.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

“Wi-Fi” also spelled Wifi, WiFi, or wifi, is a local area wireless technology that allows an electronic device to exchange data or connect to the internet using 2.4 GHz UHF and 5 GHz SHF radio waves. The name is a trademark name and is a play on the audiophile term Hi-Fi. The Wi-Fi Alliance defines Wi-Fi as any “wireless local area network (WLAN) products that are based on the Institute of Electrical and Electronics Engineers' (IEEE) 802.11 standards”.[1] However, since most modern WLANs are based on these standards, the term “Wi-Fi” is used in general English as a synonym for “WLAN”. Only Wi-Fi products that complete Wi-Fi Alliance interoperability certification testing successfully may use the “Wi-Fi CERTIFIED” trademark.

### SUMMARY OF THE INVENTION

The present invention is a cloud-based AI powered indoor environment technology that improves energy consumption by additional 15-30% and tenant retention by up to 90%.

Installed on the top of an already existing building management system (BMS), using buildings' sensors, the system collects large amounts of data on indoor climate, air quality, and space usage for each room. These data, together with the externally sourced data on weather, electricity prices, room bookings, etc. are then processed by machine learning algorithms.

The present invention also actively interacts with building occupants via an internally developed mobile phone app. This allows the algorithms to define personal levels of comfort for each building user. Profoundly understanding both, buildings and humans, the algorithms optimize work of heating, ventilation and air conditioning (HVAC) in such a way that the energy consumption is reduced whereas the indoor comfort is tailored precisely to the occupants' preferences.

Energy consuming systems are controlled by AI and are operated efficiently. This, together with active participation of building users, results in substantial reduction of energy consumption, and, this way, we significantly cut down CO2 emissions. This impacts climate change in a very positive way, as according to European Commission, buildings are responsible for 40% of energy consumption and 36% of all CO2 emissions in the EU.

Energy Performance of Buildings Directive and Energy Efficiency Directive are the EU's main legislation covering the reduction of energy consumption in buildings. The latest 2018 version of the EU Commission's Energy Performance of Buildings Directive explicitly promotes the use of smart technology in buildings, and the present invention is such a technology.

### BRIEF DESCRIPTION OF THE DRAWINGS

The accompanying drawings, which are incorporated herein form a part of the specification, illustrate the present invention and, together with the description, further explain the principles of the invention and to enable a person skilled in the pertinent art to make and use the invention.

FIG. 1 is a flow chart illustrating the high-level logic view of the system of the present invention for the hardware connectivity enabling the system and method of the present invention.

FIG. 2 is a flow chart illustrating the high-level logic view of one exemplary application of the system of the present invention for the voting and user interaction system and method of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention is a smart indoor environment technology that improves energy consumption in buildings. Using sensors, the system collects large amounts of data on indoor climate, air quality, and space usage for each room. The data are then processed by machine learning algorithms. The algorithms optimize all building processes, such as the work of heating, ventilation and air conditioning (HVAC) and lighting, but can be adapted and applied to any other process that can be controlled related to building systems and energy consumption and conservation. This way, the present invention minimizes electric power consumption for a building, and improves air quality and temperature comfort in the premises. By making consumption of electricity smarter, buildings become more energy efficient. This, in its turn, also results in reduction of CO2 emissions by the buildings.

Building process discussed in the present invention are directed to HVAC and lighting as exemplary embodiments. Building processes can also include: lighting, ventilation, humidity, water temperature, and elevators speed. Any process that relates to a building occupants' experience, which has an output that can be monitored by a sensors and an input that can be controlled by a computer or other electronic system can be applicable to the present invention.

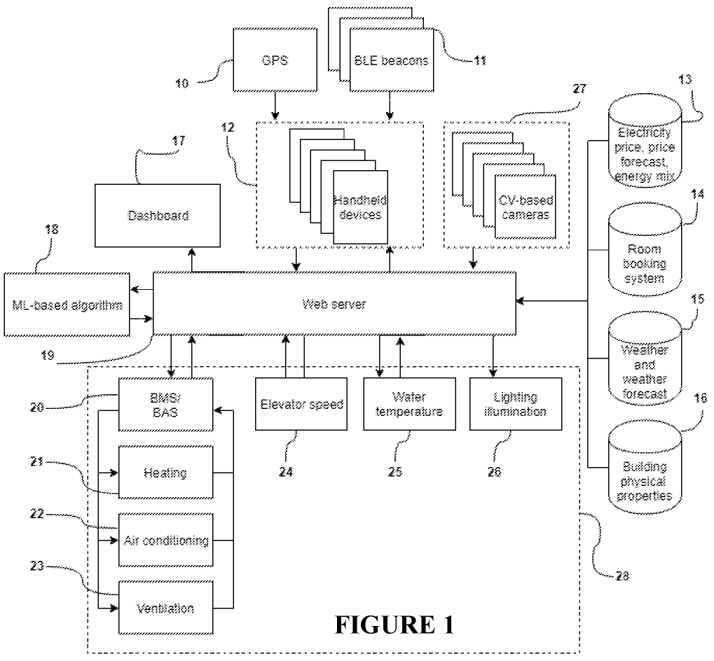

Now referring to FIG. 1, the hardware components and connectivity enabling the system and method of the present invention are illustrated. An application, installed on building occupants' handheld devices (12) (a mobile phone, a smartphone or a tablet), collects outdoor positioning data from a GPS module (10) and indoor positioning data from BLUETOOTH Low Energy (BLE) beacons (11) that are installed across the building. These beacons could be equipped with environmental sensors (e.g. temperature, humidity, air quality, carbon dioxide, volatile organic compounds etc.) whose values are transmitted to the handheld device. These values are shown on the screen of the handheld devices, in order to notify the user of the indoor climate in real time and to help the user to make decisions in the voting process.

Data on positioning and the indoor climate are sent to the web server (19). The positioning data are used to train a machine learning (ML) algorithm (18) that predicts a number of persons for each room in a building. Alternatively, surveillance or computer vision-based cameras (27) could be used in recognition of the number of building occupants in each building premise.

A machine learning (ML) algorithm is supplied through the webserver (19) with the following data: Positioning and a number of building users (10, 11, 27), Measurements from environmental sensors installed in BLE beacons (11), Real-time electricity prices for the building (13), The next hour and day ahead electricity price forecast for the building (13), Energy mix of the generated energy for the building (real time and forecast) (13). Room bookings database (14), Real-time weather and weather forecast for the building (15), Building physical properties, such as the material from which the building was built and the internal partitions, the building plan etc (16), and Data collected by sensors and thermostats that are already installed in the building (28) and that are a part of HVAC or any other building automation system, e. g. air temperature of building premise, humidity, carbon dioxide level, fan speed, open/closed position of HVAC valves, elevator or escalator speed, and water temperature of the internal water heater. These data could be parsed from the building management system (BMS) or building automation system (BAS) (21, 22, 23, 24, 25, 26).

After processing all input data, the ML algorithm defines the occupants that participate in the voting, the indoor space (e.g. a room, a floor, any other part of the building) for which the voting is initiated, the system that should be temporarily adjusted (e.g. HVAC, elevators, water temperature, etc.), the target for the adjustment (e.g. a new absolute value, a percentile or a multiple change), and the period of time for which the adjustment should be made. After the ML algorithm has compiled the vote proposal, the web server sends the vote push-messages to the voting participants.

The main optimization target for the ML algorithms is to minimize energy costs and greenhouse gases emissions (carbon dioxide equivalent) for buildings. Apart from minimization of energy consumption, these targets could also be achieved faster by cutting down energy consumption during electricity peak loads, and also by decreasing the base load of building's systems for a certain amount of time or completely turn off some of the building's systems whenever it is not used by the building occupants.

All collected data and voting results are stored in a database and through the web server could be visualized by a dashboard.

The main operating principle of the collective building energy consumption optimization is the voting process. The voting process is based on collective decision of building/room occupants to decrease energy consumption of various indoor environment related systems. The voting process can also be described as a “building democracy”, as the voting process enables a method and process which provides a “democracy in buildings/rooms”. Through the application or app of the present invention, individuals in a building exercise power by voting for such things as air temperature by controlling an HVAC system, water temperature, lighting levels through direct lighting and indirect through window controls and other settings and controls of a building.

An example of such systems is indoor air conditioning. In order to decrease energy consumption, occupants could agree to having a higher temperature in their premises, so that there would be less air conditioning needed.

Based on building occupants indoor positioning and their working place in the building, the ML-algorithm, through the web server sends a vote push-message to selected building occupants. The persons, who receive a message choose to participate in the action suggested by the message, not to participate, or reply with a special request to scrap the voting no matter what due to, for example, health-related problems. Based on the decisions (participate or not to participate) made by the majority, the building management system adjusts the proper building's indoor environment system (HVAC, lighting, etc.).

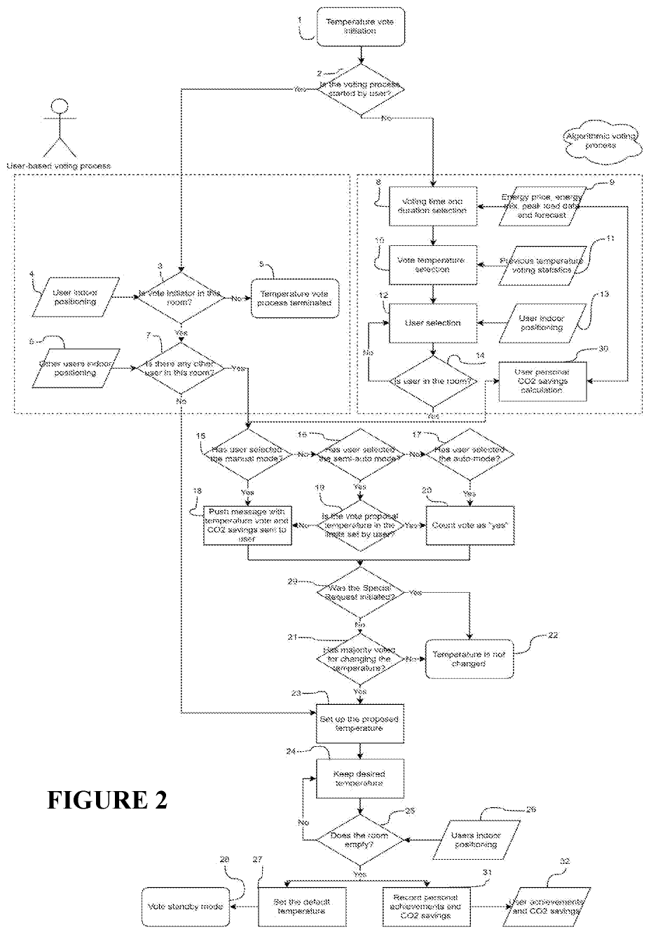

Now referring to FIG. 2, a detailed high level logic diagram illustrates one exemplary application of the system and method of the present invention, using a case of the room temperature as one of these indoor environment systems.

The vote could be initiated (1) manually or by an algorithm (2). A manual vote initiation is done when one of building occupants starts the voting process. Based on user indoor positioning (4), the system checks (3) whether the vote initiator is in the room for which she starts a vote, or, otherwise, has a permission to control the temperature in this room. If the vote initiator is not in this room or has no permission to control the temperature, the vote process is terminated (5). After this initial permission validation, the system checks how many building occupants are there in the room (7) and how many occupants there will be, based on current and forecasted data for other building occupants positioning (6). If there is only the vote initiator, the process moves directly to the temperature setup (23). If there are other occupants than the vote initiator in the room, the system checks which voting mode is selected by each occupant.

Building occupants can choose between three different voting modes, to adjust the level of their personal participation in the voting to their likings. If the Manual mode (15) is activated, the occupant will receive all vote proposals in the form of a push message while being in the room for which the vote is designated. The Semi-auto (16) mode allows to preset the levels for preferred comfort temperature by the occupant. If the vote proposal is within the defined limits (19), the vote is automatically considered as accepted (20). If the vote proposal is outside of the comfort temperature limits, the push message with the vote proposal will be sent to the occupant to vote on it (18). If the Auto mode (17) is selected, no further action is required from the occupant, since any vote proposals are considered as accepted (20).

All votes have a time limit during which the participating occupants can participate in it. Only the majority of occupants that have participated during this time when the vote is live counts. If the majority has voted positively (21), the proposed temperature is set for the room (23). The majority can be defined differently, e.g. over 50%, two thirds, etc., and can vary from building to building. If the majority has voted negatively, or there has been a draw, i.e. 50% are for and 50% are against, the temperature is not changed (22). If the Special Request (29) was activated, the temperature is not changed. The system constantly keeps the approved temperature (24) until the room is empty (25), which is based on users indoor positioning data (26). As soon as the room becomes empty, the temperature automatically is set back to its default level (27). Ultimately, the system goes in standby vote mode (28) until a new vote is started by an occupant or an algorithm.

If the vote is initiated by an algorithm, it is this algorithm that sets the new target temperature for the room, and the period of time for which the temperature should be kept at the target level. The algorithm's decisions are based on energy prices, energy mix, peak load data, etc. (8). The target temperature (10) is also set based on the previous voting statistics (11), in order to increase the chance of positive voting by participants. The selection of the voting participants (12) is based on occupant indoor positioning (13), to select (14) only those occupants who are in the room now, or have a high likelihood to be in the room during the time period for which the temperature should be changed.

Building occupants are motivated to lower their energy consumption by seeing the effect that the reduced room air temperature, or any other adjustment to the indoor environment, has on the occupants' personal greenhouse gases/carbon emissions statistics (32). The reduction effect for each participating user is estimated based on the commonly accepted methodologies and a number of building occupants (30).

Occupants also receive achievement badges for reaching various targets (31) (e.g. carbon emissions saved, a number of votes initiated, a level of comfort given up, a period of time for which comfort is given up, etc.), acting in a special way (e.g. actively engaging other building occupants to participate in carbon emissions reductions, acting individually or as a part of a team, active achievements sharing on social media, etc.), as a part of a group of occupants (a team), or for individual efforts.

Occupants can compete with each other, and can also set recurring and non-recurring (one-time) personal and team goals and invite other occupants to participate in achieving these goals, and upon reaching these goals the participants also receive achievement badges. There are also individual and team challenges that algorithms suggest to occupants, and should the occupants accept these challenges and successfully complete these challenges, the occupants are rewarded with achievement badges. The achievement badges and other tokens specify the achievements to a varying degree of detail, could also not have any specification, and could be shared on third party social media.

Most non-residential buildings have installed a Building Management System (BMS). A BMS is a computer-based control system for monitoring and regulating mechanical and electrical equipment such as HVAC (heating, ventilation, air conditioning), lighting, power systems, fire and security systems, among others. Similar control systems, such as Energy Management System (EMS) and Building Energy Management System (BEMS), focus on mainly on energy control, but most of the EMS/BEMS functionalities have been added to modern BMSs.

The BMS is typically accompanied by a variety of sensors installed in the building, feeding the system with local data. The system is managed by building management, who controls and adjusts the processes to optimize performance. The building management will adjust the BMS to serve the needs of the occupants, but state-of-the-art solutions don't include dynamic feedback from occupants nor awareness of how many occupants are in the building and what their preferences are.

Therefore, BMSs are always out of sync with the living needs of the building users, making them wasteful compared to smarter solutions. Consequently, current solutions are building-centric and centralized systems, as opposed to optimizing for real time comfort and usage parameters of building occupancy considering individual likings.

Without the possibility of receiving dynamic feedback from occupants, the BMS is set according to common rules for each of the processes. Using temperature as an example, the temperature in non-residential buildings is often set using the objective measure of metabolic equivalent (MET). However, this measure does not consider differences in body size, age and gender, which all affect thermal preference.

Depending on the range of the occupants, individual thermal preference may deviate significantly from the temperature set using MET. Considering that thermal discomfort negatively impacts productivity performance , there is a need for a better measure for adjusting the temperature according to the thermal preference of individuals in each room of the building (democratically empowering workers) while at the same time raising awareness on the fine balance between occupant comfort and CO2 emissions created by climate control systems in non-residential buildings.

With respect to an embodiment where automatic indoor climate adjustment is based on user predefined preferences and indoor positioning, every occupant that installed and app on her/his handheld device has an ability to define the personal thermal comfort settings. These settings will be stored on a handheld device and on the web server. Every time, when an occupant with the app installed will enter the room, the indoor positioning system will recognize the occupant by his/her app profile settings and indoor positioning coordinates, and adjust indoor climate setpoints based on the setting earlier predefined by the occupant or an algorithms that defines optimal comfort parameters for the occupant, based on the interactions that the occupant has had with the app. This process happens automatically without any occupant intervention. A user does not need to interact with the app during this process, since the app (that also interacts with the system server) constantly work in the background.

If the same room is occupied by several occupants with app installed on their handheld devices, the optimal thermal comfort will be averaged and based on each occupant thermal comfort settings, that were predefined in the app by each individual user or by the ML algorithms. Every time when a user enters or leaves the room, the room thermal settings will be adjusted (when a user comes in, the settings adjusted to her/his optimal; when a user leaves, the settings go back to their default parameters, which are aimed at maximizing energy savings). When the room is empty, the room thermal settings will be adjusted to the maximum energy saving mode.

In a case when ML algorithms predict that a particular user will arrive to a given room at some point in time, the algorithms will start to adjust the room thermal setpoints in the way to insure the user predefined thermal preferences will be reached when the user actually enters the room. The same principle applies when the ML algorithms predict several users will be using a room at the same time.

With respect to an embodiment enabling occupant working desk selection based on thermal heat map, based on a building's physical properties and indoor and outdoor environmental sensors data, ML algorithms generate a heat distribution map of a room. By visualizing the heat distribution in a room and matching it with the room plan and working desks positioning, an app user can choose a working place that would better fit her/his thermal comfort preferences.

Based on user predefined thermal preferences, ML algorithms can also advise each user on which room and working desk the user should select.

With respect to an embodiment incorporating an HVAC optimization principle based on epidemics situations, based on external data, an ML algorithm detects the seasonal viral infections. Based on a profile of the ongoing virus, the ML algorithm will adjust the indoor thermal setpoints in such a way that it would prevent spreading the virus inside of a building. For example, some viruses do not tolerate high humidity, and algorithm would increase humidity for the building rooms during the night, and this way reduce the number of the air-borne virus particles, and, with this, lower chances for contamination for the building occupants.

When a room is over-occupied (the average distance among building occupants is less than the predefined safe distance, like that of for COVID-19) during viral infection, an algorithm will send a push-message to everyone who is in this room and who have installed the app on her/his hand-held device suggesting some occupants to leave the over-occupied rooms and reminding all occupants to keep the safe distance.

With respect to low carbon emissions-based HVAC operation optimization, HVAC energy consumption could be optimized based on local energy mix, which is a mix of energy generated by different sources for a given point in time. The energy consumption could be lowered when more carbon intensive energy generation prevails over eco-friendly energy generation methods, with the aim to lower carbon emissions. At the same time, when the energy mix is more carbon-neutral, the algorithms make HVAC consume more energy to preheat or cool down the room (before the energy mix becomes more carbon intense again). The optimization information could be visualized and shown in an app or a dashboard.

The system and method of the present invention is set to run on one or more computing devices, mobile electronic devices, or a combination thereof. A computing device or mobile electronic device on which the present invention can run would be comprised of a CPU, storage device, keyboard, monitor or screen, CPU main memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in several different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for a cloud-based, AI powered indoor environment system for smart climate technology control for buildings, comprising
a computer system running software executing a computer program;
the computer communication with one or more sensors;
the computer system collecting data on indoor climate, air quality, and space usage for each room from the sensors;
the data are then processed by machine learning algorithms of the software;
the algorithms optimize the work of heating, ventilation and air conditioning (HVAC).

2. The system of claim 1, further comprising:
an application, installed on one or more of the building occupants' handheld devices;
the application collecting outdoor positioning data from a GPS module and indoor positioning data from BLUETOOTH Low Energy (BLE) beacons installed across the building.

3. The system of claim 2, wherein
the beacons are equipped with environmental sensors for temperature, humidity, air quality, carbon dioxide, and volatile organic compounds whose values are transmitted to the handheld device; and
these values are shown on the screen of the handheld devices, in order to notify the user of the indoor climate in real time and to help the user to make decisions in the voting process.

4. The system of claim 2, wherein
data on positioning and the indoor climate are sent to the web server; and
positioning data are used to train a machine learning (ML) algorithm that predicts a number of persons for each room in a building.

5. The system of claim 1, wherein
a machine learning (ML) algorithm is supplied through a webserver with one or more of the following data items:
positioning and a number of building users,
measurements from environmental sensors installed in BLE beacons, Real-time electricity prices for the building,
the next hour and day ahead electricity price forecast for the building,
energy mix of the generated energy for the building (real time and forecast);
room bookings database, Real-time weather and weather forecast for the building, building physical properties,
the building plan, and
data collected by sensors and thermostats that are already installed in the building and that are a part of HVAC or any other building automation system.

6. The system of claim 5, wherein
after processing all input data, the ML algorithm defines the occupants that participate in the voting;
the indoor space for which the voting is initiated, the system that should be temporarily adjusted;
the target for the adjustment (e.g. a new absolute value, a percentile or a multiple change), and the period of time for which the adjustment should be made; and
after the ML algorithm has compiled the vote proposal, the web server sends the vote push-messages to the voting participants.

7. The system of claim 6, wherein
the main operating principle of the collective building energy consumption optimization is the voting process;
the voting process is based on collective decision of building/room occupants to decrease energy consumption of various indoor environment related systems; and
all collected data and voting results are stored in a database and through the web server could be visualized by a dashboard.

8. The system of claim 6, wherein
based on building occupants indoor positioning and their working place in the building, the ML-algorithm, through the web server, sends a vote push-message to selected building occupants;
the persons, who receive a message choose to participate in the action suggested by the message, not to participate, or reply with a special request to scrap the voting no matter what due to, for example, health-related problems; and
based on the decisions to participate or not to participate made by the majority, the building management system adjusts the proper building's indoor environment system.

9. A method for a cloud-based, AI powered indoor environment system for smart climate technology control for buildings providing a voting process for the collective building energy consumption optimization, comprising the steps of:
a computer system running software executing a computer program providing a voting process for the collective building energy consumption optimization;
the vote could be initiated manually or by an algorithm;
a manual vote initiation is done when one of building occupants starts the voting process;
based on user indoor positioning, the system checks whether the vote initiator is in the room for which she starts a vote, or, otherwise, has a permission to control features in this room;
if the vote initiator is not in this room or has no permission to control the room features, the vote process is terminated;
after this initial permission validation, the system checks how many building occupants are there in the room and how many occupants there will be, based on current and forecasted data for other building occupants positioning; and
if there is only the vote initiator, the process moves directly to the feature setup;
if there are other occupants than the vote initiator in the room, the system checks which voting mode is selected by each occupant.

10. The method of claim 9, wherein
the feature being controlled is temperature;
based on user indoor positioning, the system checks whether the vote initiator is in the room for which she starts a vote, or, otherwise, has a permission to control the temperature in this room;
if the vote initiator is not in this room or has no permission to control the temperature, the vote process is terminated;
after this initial permission validation, the system checks how many building occupants are there in the room and how many occupants there will be, based on current and forecasted data for other building occupants positioning.

11. The method of claim 9, further comprising the step of
building occupants can choose between three different voting modes, to adjust the level of their personal participation in the voting to their likings.

12. The method of claim 11, wherein
if the Manual mode is activated, the occupant will receive all vote proposals in the form of a push message while being in the room for which the vote is designated.

13. The method of claim 11, wherein
a Semi-auto mode allows to preset the levels for preferred comfort temperature by the occupant.
if the vote proposal is within the defined limits, the vote is automatically considered as accepted; and
if the vote proposal is outside of the comfort temperature limits, the push message with the vote proposal will be sent to the occupant to vote on it.

14. The method of claim 11, wherein
if the auto mode is selected, no further action is required from the occupant, since any vote proposals are considered as accepted.

15. The method of claim 11, wherein
all votes have a time limit during which the participating occupants can participate in it;
only the majority of occupants that have participated during this time when the vote is live counts;
if the majority has voted positively, the proposed temperature is set for the room.

16. The method of claim 9, wherein
the majority can be defined differently, e.g. over 50%, two thirds, etc., and can vary from building to building.

17. The method of claim 16, wherein
if the majority has voted negatively, or there has been a draw, i.e. 50% are for and 50% are against, the temperature is not changed;
if the Special Request was activated, the temperature is not changed;
the system constantly keeps the approved temperature until the room is empty, which is based on users indoor positioning data;
as soon as the room becomes empty, the temperature automatically is set back to its default level; and
ultimately, the system goes in standby vote mode until a new vote is started by an occupant or an algorithm.

18. The method of claim 9, wherein
if the vote is initiated by an algorithm, it is this algorithm that sets the new target temperature for the room, and the period of time for which the temperature should be kept at the target level.

19. The method of claim 18, wherein
the algorithm's decisions are based on energy prices, energy mix, and peak load data;
the target temperature is set based on the previous voting statistics, in order to increase the chance of positive voting by participants; and
the selection of the voting participants is based on occupant indoor positioning, to select only those occupants who are in the room now, or have a high likelihood to be in the room during the time period for which the temperature should be changed.

20. The method of claim 19, wherein
occupants also receive achievement badges for reaching various targets;
carbon emissions saved,
a number of votes initiated,
a level of comfort given up, a period of time for which comfort is given up, acting in a special way including actively engaging other building occupants to participate in carbon emissions reductions, acting individually, or
as a part of a team, active achievements sharing on social media, and as a part of a group of occupants (a team), or for individual efforts.

21. The method of claim 20, wherein
occupants compete with each other, and set recurring and non-recurring (one-time) personal and team goals and invite other occupants to participate in achieving these goals, and upon reaching these goals the participants also receive achievement badges;
there are individual and team challenges that algorithms suggest to occupants, and should the occupants accept these challenges and successfully complete these challenges, the occupants are rewarded with achievement badges; and
the achievement badges and other tokens specify the achievements to a varying degree of detail, could also not have any specification, and could be shared on third party social media.
